(19) United States
(12) Patent Application Publication
(10) Pub. No.: US 2008/0113525 A1
(43) Pub. Date: May 15, 2008

(54) Compact solid state drive and processor assembly

(75) Inventor: Ofer Tzur, Shoham (IL)

Correspondence Address: MARK M. FRIEDMAN, C/O DISCOVEY DISPATCH , 9003 FLIRIN WAY, UPPER MARLBORO, MD, 20772, US

(73) Assignee: SanDisk IL Ltd.

(21) Appl. No.: 11/730,598

(22) Filed: Apr. 3, 2007

Related U.S. Application Data
(60) Provisional application No. 60/865,850, filed on Nov. 15, 2006.

(51) Int. Cl. H01R 12/00

(52) U.S. Cl. 439/55

(57) ABSTRACT

A hardware assembly of a non-volatile solid state drive and a processor is made more compact by eliminating elements previously associated with such assemblies. For embodiments implementing a SATA cable to electrically connect the solid state drive and processor, the SATA cable directly connects the two elements without implementing intervening bulky SATA connectors. For embodiments implementing a printed circuit board for mounting the solid state drive and processor, the SATA cable itself may be eliminated by replacing it with a hardwired signal path on the printed circuit board. These compact hardware assemblies are manufactured by hardwiring the signal path to the solid state drive at a SATA interface and hardwiring the same signal path to the processor also such that the hardwired signal path electrically connects the solid state drive to the processor.

### RELATED APPLICATION

This application claims priority under 35 U.S.C. § 119(e) to U.S. Provisional Application No. 60/865,850, filed Nov. 15, 2006, which is hereby incorporated by reference in its entirety.

### BACKGROUND

Due to the widespread demand for portability, electronic products are constantly being redesigned into smaller, lighter packages. Examples of such electronic products are laptop computers, personal digital assistants (PDAs), and multimedia players. Even regarding larger products for which portability on a daily basis is not usually required, such as desktop computers, the desire for smaller and lighter packages nonetheless exits.

Some electronic products have components that are less desirable if reduced in size beyond a certain point. For example, displays and keyboards of personal computers, which if reduced too much in size, become more difficult to use. In contrast, internal electrical components may generally be reduced in size as much as possible without causing the same disadvantages to the users.

One trend in reducing hardware size arises from the advancements in memory technology. One specific example is use of a solid state drive (SSD), sometimes referred to as a “solid state disk,” to replace the larger, more conventional hard disk drive (HDD). Related to this example is the use of a SATA cable to connect the memory to a processor. The SATA cable is a replacement for the more conventional and larger ATA cable. (The term “SATA” is an acronym for “Serial ATA,” and “ATA” is an acronym for “Advanced Technology Attachment.” Both SATA and ATA are commonly used for connecting computer elements.)

FIG. 1 illustrates a typical prior art hardware assembly 10 comprising a non-volatile solid state drive 12 electrically connectable to a processor 14, which may be a central processing unit (CPU) of a personal computer. Solid state drive 12 has a SATA interface 15. Solid state drive 12 and processor 14 are mounted on a printed circuit board 16, and a SATA cable 18 electrically connects solid state drive 12 at SATA interface 15 to processor 14.

SATA cable 18 comprises a first SATA cable segment 18a and a second SATA cable segment 18b. First SATA cable segment 18a electrically connects SATA interface 15 of solid state drive 12 to a SATA connector 20a, and second SATA cable segment 18b electrically connects processor 14 to a mating SATA connector 20b. SATA connector 20a and SATA connector 20b join together to complete the electrical signal path from solid state drive 12 to processor 14.

If solid state drive 12 becomes defective, or if an upgraded solid state drive becomes available, solid state drive 12 can be disconnected from processor 14 and removed from hardware assembly 10. To disconnect solid state drive 12 from processor 14, SATA connector 20a and SATA connector 20b are disconnected from each other, and solid state drive 12 is removed from printed circuit board 16. Then, the replacement solid state drive is mounted on printed circuit board 16. The replacement solid state drive has SATA cable segment, and its connector is joined to SATA connector 20b to electrically connect the replacement solid state drive to processor 14.

Among the elements in hardware assembly 10, SATA connectors 20a, 20b are relatively large. Thus, concerning the trend to design more compact electronic products, some hardware designers might be motivated to develop a more compact SATA connector. However, it is not clear how much the size of the SATA connector can be reduced without jeopardizing its functionality and its compliance with SATA standards.

### SUMMARY

The present inventor has found a way to design a more compact hardware assembly of a solid state drive and a processor. Instead of developing a more compact SATA connector, though, he eliminates SATA connectors altogether from the hardware assembly, and the result is an even greater space saving than simply reducing the size of the SATA connectors. Some embodiments of the invention include a printed circuit board, and in some of these embodiments the SATA cable is also eliminated. The SATA cable is replaced with an electrical path on the printed circuit board to achieve an even greater space savings.

That is, although the conventional response to the need for more compact hardware systems is to design smaller components, the present inventor eliminates components instead. To the best knowledge of the inventor, such improvement in prior art hardware assemblies of solid state drives and processors has never been developed in the past, perhaps due to the conventional interest in preserving the option to replace defective drives. Seemingly escaping consideration is the increasing life expectancy of solid state drives and the decreasing term of use of many electronic devices due to continuing technological developments. That is, products are often replaced while still properly functioning only because more sophisticated products have become available. Thus, the reduced space requirements of the inventive hardware assembly are well worth the sacrificed option of component interchangeability.

The present invention can be embodied as different hardware assemblies and as different methods of manufacture thereof. The hardware assemblies each have a non-volatile solid state drive, a processor, and a hardwired signal path that electrically connects the solid state drive, at a SATA interface, to the processor. Implementing a “hardwired signal path” means using no sockets, plugs, jacks, and so on in the signal path connecting the solid state drive to the processor. The inventive methods of manufacturing hardware assemblies include hardwiring the signal path to the solid state drive at the SATA interface and hardwiring the same signal path to the processor also such that the hardwired signal path electrically connects the solid state drive to the processor.

The hardwired signal path may include a SATA cable directly connected to the solid state drive at said SATA interface, to the processor, or to both. In some embodiments in which the SATA cable does not directly connect to both the solid state drive and the processor, the hardware assembly implements a printed circuit board.

In embodiments that implement the printed circuit board, the solid state drive, the processor, or both are mounted thereon. If either the solid state drive, the processor, or both are mounted on the printed circuit board but are not directly connected to the SATA cable, the hardwired signal path includes a printed circuit path on the printed circuit board. The printed circuit path may be an electrical path that operationally connects the solid state drive and/or the processor to the SATA cable. In alternate embodiments, the solid state drive and the processor are mounted on separate printed circuit boards.

Some embodiments of the invention implement a NAND-type flash memory storage device as the solid state drive. Many variations of the embodiment are conceivable, and exemplary embodiments are described in detail below with reference to the accompanying drawings. These drawings are briefly described as follows:

### BRIEF DESCRIPTION OF THE DRAWINGS

The invention is described below in the appended claims, which are read in view of the accompanying description including the following drawings, wherein:

FIG. 1 illustrates a prior art hardware assembly, which includes bulky SATA cable connectors;

FIG. 2 illustrates an embodiment of the invention eliminating the SATA cable connectors;

FIG. 3 illustrates an alternate embodiment of the invention, which includes two circuit boards;

FIG. 4 illustrates another alternate embodiment of the invention, which includes electrical paths printed on the two circuit boards;

FIG. 5 illustrates still another embodiment of the invention, which includes two electrical paths printed on one circuit board; and

FIG. 6 illustrates yet another embodiment of the invention, which eliminates the SATA cable from the hardware assembly.

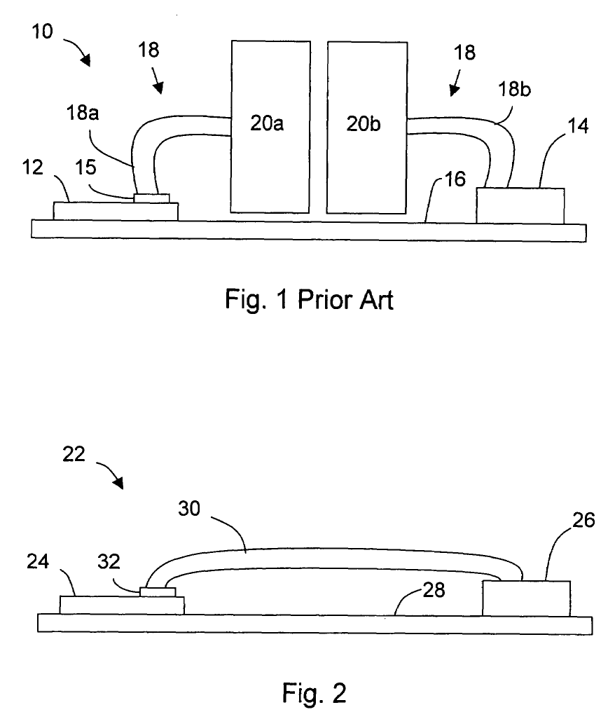

### DETAILED DESCRIPTION

The invention summarized above and defined by the claims below will be better understood by referring to the present detailed description of embodiments of the invention. This description is not intended to limit the scope of claims but instead to provide examples of the invention. Described first are embodiments of hardware assemblies. Described later are embodiments of methods of manufacturing hardware assemblies.

FIG. 2 illustrates an embodiment of the invention in which a hardware assembly 22 comprises a non-volatile solid state drive 24 electrically connected to a processor 26. Solid state drive 24 may be a NAND-type flash memory storage device, and processor 26 may be a central processing unit (CPU) of a personal computer. Solid state drive 24 and processor 26 are mounted on a printed circuit board 28.

Solid state drive 24 and processor 26 are electrically connected together using a SATA cable 30 without the bulky SATA cable connectors of the prior art. SATA cable 30 is directly connected to solid state drive 24 at a SATA interface 32 and to processor 26 to form a hardwired signal path. That is, a continuous electrical path extends from solid state drive 24 at SATA interface 32 to processor 26 instead of a “discontinuous” electrical path comprising multiple separate metal leads pressed together to maintain electrical contact. The electrical path has no jacks, plugs, sockets, etc., so hardware assembly 22 is simpler, less expensive, and more compact.

Although this embodiment includes a printed circuit board, it should be clear that the present invention is not limited accordingly. It is fully within the scope of the invention that an embodiment of a hardware assembly would not include a printed circuit board.

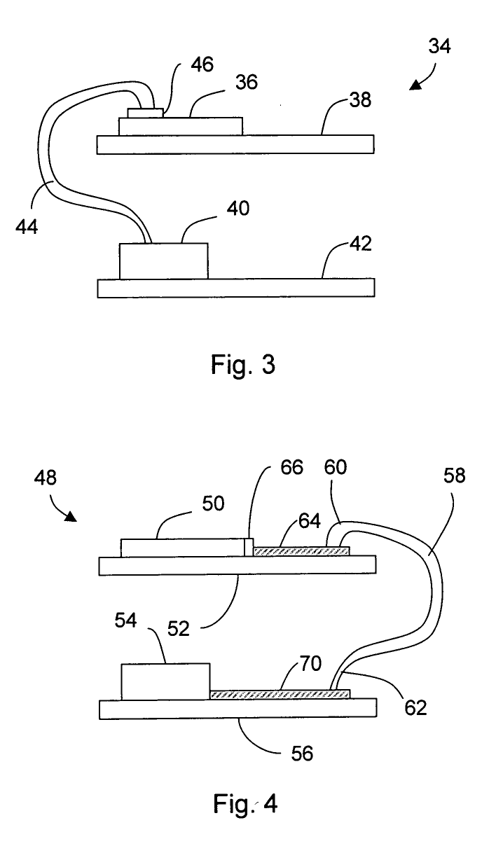

FIG. 3 illustrates an alternate embodiment of the invention, which has two separate circuit boards instead of one. In a hardware assembly 34, a solid state drive 36 is mounted on a first printed circuit board 38, and a processor 40 is mounted on a second printed circuit board 42. Solid state drive 36 and processor 40 are electrically connected together using a SATA cable 44. SATA cable 4 is directly connected to solid state drive 36 at a SATA interface 46 and to processor 40 to form a hardwired signal path. This embodiment can be useful in systems requiring a reduced planar extent of a circuit board when an additional circuit board parallel to an existing board(s) is tolerated.

FIG. 4 illustrates another alternate embodiment of the invention, which includes electrical paths on the two circuit boards. In a hardware assembly 48, a solid state drive 50 is mounted on a first printed circuit board 52, and a processor 54 is mounted on a second printed circuit board 56. A SATA cable 58 forms part of a hardwired signal path connecting solid state drive 50 and processor 54. However, unlike the embodiments discussed above, neither solid state drive 50 nor processor 54 are directly connected to the SATA cable.

Instead, SATA cable 58 is hardwired at a first end 60 to first printed circuit board 52 and at a second end 62 to second printed circuit board 56. An electrical path 64 on first printed circuit board 52 operationally connects solid state drive 50 at a SATA interface 66 to a first end 60 of SATA cable 58, and an electrical path 70 on second printed circuit board 56 operationally connects processor 54 to second end 62 of SATA cable 58.

The present disclosure references the electrical paths of printed circuit boards as “on” the boards, but the usage of this terminology is not intended to exclude embodiments in which the electrical paths are physically located between upper and lower board surfaces. The single term “on” is used for brevity instead of redundantly reciting “on or in” in the description of each embodiment. The drawings generally show the path on the board for clarity only and not to distinguish from embodiments having embedded electrical paths.

In the embodiment of FIG. 4, the electrical paths may comprise conductive material printed on the respective printed circuit. With this embodiment, a SATA cable may be connected close to the edge of a printed circuit board(s) while the solid state drive, the processor, or both may be positioned farther from the edge(s).

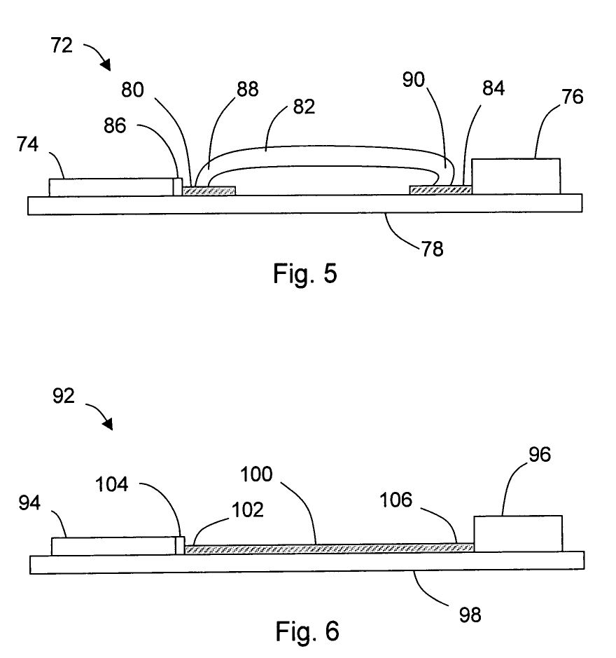

FIG. 5 illustrates still another embodiment of the invention, which includes two electrical paths on the same circuit board. In a hardware assembly 72, a hardwired signal path connects a solid state drive 74 and a processor 76, both of which are mounted on a printed circuit board 78. The hardwired signal path comprises a first electrical path 80, a SATA cable 82, and a second electrical path 84. First and second electrical paths 80, 84 may be conductive material printed on printed circuit board 78. First electrical path 80 operationally connects solid state drive 74 at a SATA interface 86 to a first end 88 of SATA cable 82, and second electrical path 84 operationally connects a second end 90 of SATA cable 82 to processor 54.

FIG. 6 illustrates yet another embodiment of the invention, which eliminates the SATA cable altogether from the hardware assembly. In a hardware assembly 92, a hardwired signal path connects a solid state drive 94 and a processor 96, both of which are mounted on a printed circuit board 98. The hardwired signal path comprises an electrical path 100, which may be conductive material printed on printed circuit board 98. There is no SATA cable in this hardwired signal path. A first end 102 of electrical path 100 operationally connects to solid state drive 94 at a SATA interface 104, and a second end 106 of electrical path 100 operationally connects to processor 96. With an electrical path that is smaller than a SATA cable, hardware assembly 92 reduces the space requirements of the invention even more.

The hardware assemblies described above are useful in laptop computers, where a small size is desirable. However, other information processors can also benefit from the space savings. For example, it is also desirable that a personal computer that is a desktop is smaller, even when portability on a daily basis is not required. The inventive hardware assembly may also be implemented in personal digital assistants (PDAs), telephones, and portable media players.

The present invention may also be embodied as a method of manufacturing a hardware assembly. Such method includes hardwiring a signal path to a non-volatile solid state drive at a SATA interface and hardwiring the same signal path to a processor also such that the hardwired signal path electrically connects the solid state drive to the processor. These hardwiring steps may be performed in any order. Hardwiring the signal path to the non-volatile solid state drive may be performed by hardwiring a SATA cable directly to the solid state drive, and hardwiring the signal path to the processor may be performed by hardwiring a SATA cable directly to the processor. The SATA cable may be directly hardwired to both the solid state drive and the processor.

The method of manufacturing a hardware assembly may include mounting the solid state drive, the processor, or both on a printed circuit board. One or both ends of the SATA cable may be hardwired to the printed circuit board. An end of a SATA cable that is hardwired to the printed circuit board is operationally connected to the solid state drive or to the processor. The method of manufacturing may include mounting the solid state drive on one printed circuit board and mounting the processor on a different printed circuit board.

Having thus described exemplary embodiments of the invention, it will be apparent that various alterations, modifications, and improvements will readily occur to those skilled in the art. Alternations, modifications, and improvements of the disclosed invention, though not expressly described above, are nonetheless intended and implied to be within spirit and scope of the invention. Accordingly, the foregoing discussion is intended to be illustrative only; the invention is limited and defined only by the following claims and equivalents thereto.

I claim:

1. A hardware assembly comprising:
a non-volatile solid state drive having a SATA interface;
a processor; and
a hardwired signal path electrically connecting said solid state drive at said SATA interface to said processor.

2. The hardware assembly of claim 1, wherein said hardwired signal path includes a SATA cable directly connected to said solid state drive at said SATA interface.

3. The hardware assembly of claim 1, wherein said hardwired signal path includes a SATA cable directly connected to said processor.

4. The hardware assembly of claim 1, wherein said hard-wired signal path includes a SATA cable directly connected to said solid state drive at said SATA interface and to said processor.

5. The hardware assembly of claim 1 further comprising:
a printed circuit board,
wherein said solid state drive and said processor are mounted on said printed circuit board.

6. The hardware assembly of claim 5, wherein said hardwired signal path includes a printed circuit path on said printed circuit board.

7. The hardware assembly of claim 5, wherein said hardwired signal path includes a SATA cable hardwired at an end to said printed circuit board, and an electrical path printed on said circuit board operationally connects said end of said SATA cable to said solid state drive at said SATA interface.

8. The hardware assembly of claim 5, wherein said hardwired signal path includes a SATA cable hardwired at an end to said printed circuit board, and an electrical path printed on said circuit board operationally connects said end of said SATA cable to said processor.

9. The hardware assembly of claim 5, wherein said hardwired signal path includes a SATA cable hardwired at a first end and at a second end to said printed circuit board, a first electrical path printed on said circuit board operationally connects said first end of said SATA cable to said solid state drive at said SATA interface, and a second electrical path printed on said circuit board operationally connects said second end of said SATA cable to said processor.

10. The hardware assembly of claim 1 further comprising:
a printed circuit board,
wherein said solid state drive is mounted on said printed circuit board.

11. The hardware assembly of claim 10, wherein said hardwired signal path includes a SATA cable hardwired at an end to said printed circuit board, and an electrical path printed on said circuit board operationally connects said end of said SATA cable to said solid state drive at said SATA interface.

12. The hardware assembly of claim 1 further comprising:
a printed circuit board,
wherein said processor is mounted on said printed circuit board.

13. The hardware assembly of claim 12, wherein said hardwired signal path includes a SATA cable hardwired at an end to said printed circuit board, and an electrical path printed on said circuit board operationally connects said end of said SATA cable to said processor.

14. The hardware assembly of claim 1 further comprising:
a first printed circuit board; and
a second printed circuit board,
wherein said solid state drive is mounted on said first printed circuit board, and said processor is mounted on said second printed circuit board.

15. The hardware assembly of claim 14, wherein said hardwired signal path includes a SATA cable hardwired at an end to said first printed circuit board, and an electrical path printed on said first circuit board operationally connects said end of said SATA cable to said solid state drive at said SATA interface.

16. The hardware assembly of claim 14, wherein said hardwired signal path includes a SATA cable hardwired at an end to said second printed circuit board, and an electrical path printed on said second circuit board operationally connects said end of said SATA cable to said processor.

17. The hardware assembly of claim 14, wherein said hardwired signal path includes a SATA cable hardwired at a first end to said first printed circuit board and at a second end to said second printed circuit board, a first electrical path printed on said first circuit board operationally connects said first end of said SATA cable to said solid state drive at said SATA interface, and a second electrical path printed on said second circuit board operationally connects said second end of said SATA cable to said processor.

18. The hardware assembly of claim 1, wherein said solid state drive is a NAND-type flash memory storage device.

19. An information processor including the hardware assembly of claim 1.

20. A personal computer including the hardware assembly of claim 1.

21. A personal digital assistant including the hardware assembly of claim 1.

22. A telephone including the hardware assembly of claim 1.

23. A portable media player including the hardware assembly of claim 1.

24. A method of manufacturing a hardware assembly, the method comprising:
hardwiring a signal path to a non-volatile solid state drive at a SATA interface; and
hardwiring the same signal path to a processor also such that said hardwired signal path electrically connects said solid state drive to said processor.

25. The method of claim 24, wherein said hardwiring a signal path to a non-volatile solid state drive includes hardwiring a SATA cable directly to a solid state drive.

26. The method of claim 24, wherein said hardwiring the same signal path to a processor includes hardwiring a SATA cable directly to a processor.

27. The method of claim 24, wherein said hardwiring a signal path to a non-volatile solid state drive includes hardwiring a SATA cable directly to a solid state drive, and said hardwiring the same signal path to a processor includes hardwiring a SATA cable directly to a processor.

28. The method of claim 24, further comprising:
mounting said solid state drive and said processor on a printed circuit board.

29. The method of claim 28, wherein said hardwiring a signal path to a non-volatile solid state drive includes:
hardwiring an end of a SATA cable to said printed circuit board; and
operationally connecting said end of said SATA cable to said solid state drive.

30. The method of claim 28, wherein said hardwiring the same signal path to a processor includes:
hardwiring an end of a SATA cable to said printed circuit board; and
operationally connecting said end of said SATA cable to said processor.

31. The method of claim 28, said hardwiring said signal path to said solid state drive and to said processor includes:
hardwiring a first end of a SATA cable to said printed circuit board;
operationally connecting said first end of said SATA cable to said solid state drive;
hardwiring a second end of said SATA cable to said printed circuit board; and
operationally connecting said second end of said SATA cable to said processor.

32. The method of claim 24, further comprising:
mounting said solid state drive on a printed circuit board.

33. The method of claim 32, wherein said hardwiring a signal path to a non-volatile solid state drive includes:
hardwiring an end of said SATA cable to said printed circuit board; and
operationally connecting said end of said SATA cable to said solid state drive.

34. The method of claim 24, further comprising:
mounting said processor on a printed circuit board.

35. The method of claim 34, wherein said hardwiring the same signal path to a processor includes:
hardwiring an end of a SATA cable to said printed circuit board; and
operationally connecting said end of said SATA cable to said processor.

36. The method of claim 24, further comprising:
mounting said solid state drive on a first printed circuit board; and
mounting said processor on a second printed circuit board.

37. The method of claim 36, wherein said hardwiring a signal path to a non-volatile solid state drive includes:
hardwiring an end of a SATA cable to said first printed circuit board; and
operationally connecting said end of said SATA cable to said solid state drive.

38. The method of claim 36, wherein said hardwiring the same signal path to a processor includes:
hardwiring an end of a SATA cable said second printed circuit board; and
operationally connecting said end of said SATA cable to said processor.

39. The method of claim 36, said hardwiring said signal path to said solid state drive and to said processor includes:
hardwiring a first end of a SATA cable to said first printed circuit board;
operationally connecting said first end of said SATA cable to said solid state drive;
hardwiring a second end of said SATA cable to said second printed circuit board; and
operationally connecting said second end of said SATA cable to said processor.
